(19) United States
(12) Patent Application Publication
(10) Pub. No.: US 2003/0038716 A1
(43) Pub. Date: Feb. 27, 2003

(54) Direct TPMS sensor combined with an ABS

(76) Inventor: Gregory Hubert Piesinger, Cave Creek, AZ (US)

Correspondence Address: GREGORY H PIESINGER, 6225 E SAGUARO VISTA CT, CAVE CREEK, AZ, 85331, US

(21) Appl. No.: 10/227,888

(22) Filed: Aug. 26, 2002

Related U.S. Application Data
(60) Provisional application No. 60/315,120, filed on Aug. 27, 2001.

(51) Int. Cl. B60C 23/00

(52) U.S. Cl. 340/445; 340/531

(57) ABSTRACT

Tire pressure sensors are combined with an ABS to obtain a very low cost direct TPMS. A direct tire pressure sensor unit is mounted in each wheel and the existing ABS wheel sensor units are modified to receive transmission signals from the direct pressure sensors. The existing ABS wheel sensor vehicle wiring is used to couple the received signals to the existing central ABS computer. The central ABS computer software is modified to process these received signals and calculate tire pressure information. This information is displayed using a TPMS display symbol.

### BACKGROUND

This invention relates to a tire pressure monitoring system (TPMS) in which the signal from a direct pressure sensor is received and decoded using circuitry within the antilock brake system (ABS).

Tire pressure monitoring systems in use today are primarily either direct or indirect systems. Direct systems use a pressure sensor inside the tire to directly measure tire pressure. Indirect systems use the ABS to derive the tire pressure by comparing the number of revolutions of each wheel while driving. The circumference of a tire with low pressure is slightly less than one with correct pressure. Therefore, the revolutions per mile of the low pressure wheel is greater and these increased revolutions can be used to detect a low tire pressure.

Indirect tire pressure systems have great appeal because they can be combined with an existing ABS. The ABS already measures the rotation of each wheel so adding an ABS based TPMS only involves modifying the ABS software and adding a warning light display to the instrument cluster.

Unfortunately, ABS indirect systems are very inaccurate. Since the decrease in circumference of tires with low pressure is very slight, a large pressure drop combined with a long driving distance must occur to trigger a low tire pressure warning. Also, if the pressure is simultaneously low in all four tires on an vehicle, no detection is possible because there is no differential wheel rotations to detect.

The performance of a direct TPMS is far superior. Since tire pressure is being measured directly, low pressure warnings can be made instantly and very accurately. Although more accurate, direct systems are much more expensive than indirect systems because new hardware must be added to the vehicle.

Essentially all modern direct TPMS are wireless systems. A pressure sensor and transmitter is placed inside the tire (typically mounted on the rim) and a receiver is mounted elsewhere on the vehicle. Most wireless systems operate at a frequency of 433 MHz or higher to obtain a large transmission range. Most systems also require a new stand-alone receiver although a few systems share the keyless entry system receiver that is installed on some luxury vehicles.

One of the largest cost drivers of direct TPMS is the cost of implementing the 433 MHz transmitter and receiver. Pressure data must be modulated onto a high frequency carrier at significant power and then demodulated back to base band in the receiver. However, much of this cost and complexity can be eliminated if individual receivers are installed adjacent to the wheel because short range low power and/or low frequency transmitter and receivers can be used.

Unfortunately, the use of multiple receivers and their required wiring to a central processor or display adds additional costs that largely offsets the cost savings obtained by going to a lower transmission power and frequency.

Piesinger in U.S. Pat. No. 6,175,301 describes a low-power low-frequency system in which only a single receiver is required. However, even with that system, additional vehicle wiring is required to implement a receiver antenna that is routed to the vicinity of each wheel.

Uhl et al in U.S. Pat. No. 6,194,999 also describes a system in which only a single receiver is required. However, their system operates at 433 MHz and requires that co-axial cable be used to route the signals from each wheel to the central receiver.

Accordingly, it is the object of the present invention to provide a new direct TPMS in which the cost advantage of a low-power low-frequency sensor transmitter is not dissipated due to the costs of multiple receivers and additional vehicle wiring.

### SUMMARY

Briefly, to achieve the desired object of the present invention, a low power and low frequency direct pressure sensor transmitter will be combined with ABS based receivers. Existing circuitry inside each ABS wheel sensor will be modified to receive and condition the pressure sensor signal.

Conditioned received sensor signals from each wheel will then be sent to the central ABS computer using existing ABS wiring. The ABS computer software will be modified to process the conditioned sensor signals and decode the pressure data.

For existing ABS indirect TPMS, the ABS computer will drive the existing display. If this is an ABS only system, a new display will be added to the vehicle instrument cluster.

### DRAWINGS

FIG. 1 illustrates the direct TPMS sensor mounted on the tire rim and a portion of the ABS brake system assembly.

FIG. 2 is a block diagram of the invention TPMS in which a direct pressure sensor is combined with the ABS system receiver, processor, and display.

### DETAILED DESCRIPTION

The goal of the present invention is to provide a low cost direct TPMS. To achieve this goal, a direct pressure sensor is combined with receiver electronics added to the existing ABS system.

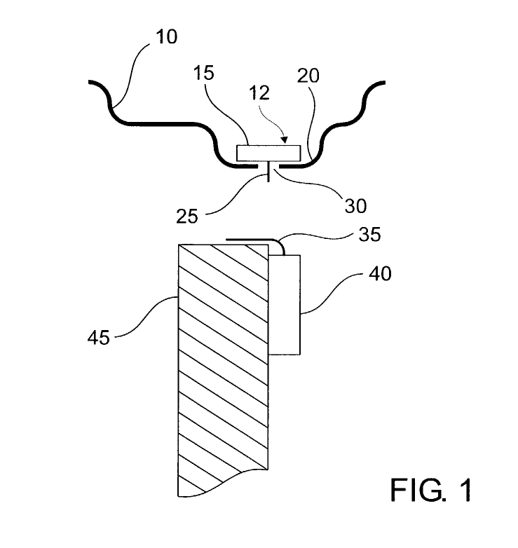

FIG. 1 illustrates a cross section of tire rim 10 in which a direct pressure sensor assembly 12 is mounted in drop well 20 of rim 10. Sensor assembly 12 consists of enclosure 15 and transmitter antenna 25. It can be secured to the rim using any convenient method such as banding, gluing, bolting, or making it part of the valve stem.

For metal rims, transmitter antenna 25 is passed through hole 30 in drop well 20 so that it protrudes into the area of brake assembly 45. Hole 30 could be of the same size as the valve stem hole and could also be used to secure sensor 12 to rim 10. If an emerging technology non-metallic rim were used, hole 30 would not be required because a non-metallic rim will not attenuate the sensor signal.

Transmitter antenna 25 could be either a short length of insulated wire that just barely protrudes through the rim or it could be a long length of insulated wire that wraps completely around the circumference of the rim. If a long wire length is used with metal rims, the wire would have to be secured to the outside surface of the rim in the brake assembly area using adhesive, wire clamps or the like. For non-metallic rims, the wire could be embedded inside the rim cross section.

Receiver antenna 35 couples the sensor signal to the receiver electronics included in ABS wheel sensor assembly 40 mounted on brake assembly 45. Receiver antenna 35 could consist of a short length of insulated wire or simply an insulated metal surface that is part of the ABS wheel sensor assembly 40. The current sensor signal wire, or shield, could also either be directly used as the receiver antenna or it could be modified to function as the receiver antenna.

Alternatively, receiver antenna 35 could be a large diameter loop assembly that wraps around the entire circumference of brake assembly 45. A large loop receiver antenna could be used in conjunction with a short transmitter antenna to allow the sensor signal to be received for any position of wheel rotation.

Conversely, a short receiver antenna could be used in conjunction with a long transmitter antenna that wraps completely around the circumference of the rim to achieve the same results. Finally, both short transmitter and receiver antennas could be used which may allow the sensor signal to be received only at those wheel rotations that place the two antennas in close proximity to each other.

Using either a long transmitter or receiver antenna allows a low tire pressure warning to be issued even when the vehicle is parked. If short antennas are used for both the transmitter and receiver, then the vehicle may have to start moving before a warning can be issued.

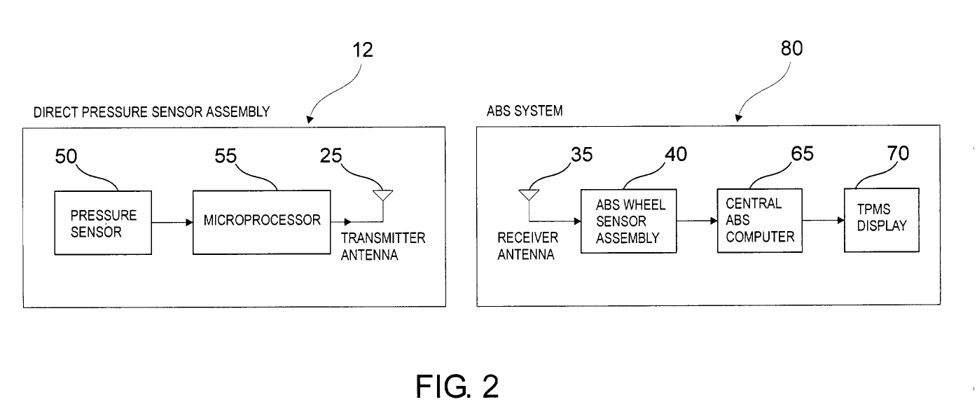

FIG. 2 is a block diagram of the complete direct ABS TPMS. Direct pressure sensor assembly 12 is combined with ABS system 80 to form the low cost TPMS.

Pressure sensor 50 is any sensor designed to detect or measure pressure. Typical technologies include the thin enclosure wall pressure switch used by Piesinger in U.S. Pat. No. 6,175,301 or any of the many IC and ASIC based pressure sensor transducers available today.

Microprocessor 55 interacts with pressure sensor 50 to format pressure data for transmission onto transmitter antenna 25. Since this is a very short range transmission system, the transmitter can be formed simply using the microprocessor. That is, a separate high frequency transmitter circuit is not required as is the case for most current direct TPMS which transmit at 433 MHz.

Many modulation algorithms can be used to transmit the pressure data as will be known to anyone skilled in the art. Piesinger in U.S. Pat. No. 6,175,301 describes a simple pseudo random noise (PN) coded transmission signal formed using a feedback shift register. Such PN coded signals can easily be programmed into a microprocessor and used to either indicate the activation of a pressure switch, or to encode actual pressure data from a linear pressure transducer.

ABS system 80 consists of receiver antenna 35, ABS wheel sensor assembly 40, central ABS computer 65 and TPMS display 70.

ABS wheel sensor assembly 40 currently contains signal conditioning, amplification, and bus interface circuitry to process the wheel rotation sensing signal. For the present invention, this circuitry will be modified to also amplify and condition the direct pressure sensor signal, received on antenna 35, and send it to the central ABS computer using the existing ABS vehicle wiring. The required modification is very simple and can be accomplished using a single low frequency operational amplifier as should be obvious to anyone skilled in the art.

This technique is in stark contrast to the technique used by Uhl et al in U.S. Pat. No. 6,194,999 which requires that the existing ABS vehicle wiring be replaced with co-axial cable. Co-axial cable is very expensive and much more difficult to install then is the existing low frequency ABS wiring.

The software in central ABS computer 65 will also be modified to process the tire pressure information and send it to TPMS display 70.

Thus, this invention provides a method by which the performance advantages of a direct TPMS can be obtained, using indirect ABS hardware, at minimum additional cost. The method allows a low cost direct pressure tire sensor to be used since no high frequency transmitter is required. The receiver and display portion of the TPMS is essentially free, just as it is for the indirect ABS TPMS, because only slight hardware and software modifications are required to an existing ABS system.

Although the preferred embodiments of the invention have been illustrated and described in detail, it will be readily apparent to those skilled in the art that various modifications may be made therein without departing from the spirit of the invention.

1. A tire pressure monitoring system comprising:
a. a wireless direct tire pressure sensor transmitter unit mounted on the wheel rim inside each tire to be monitored;
b. receiver antenna and electronics added to each existing ABS wheel sensor assembly to receive and condition the tire pressure sensor's transmission signal and forward it to the existing central ABS computer using existing ABS wheel sensor vehicle wiring;
c. modified software in the central ABS computer to process the conditioned tire pressure sensor's transmission signals received from each ABS wheel sensor; and
d. a TPMS display to indicate tire pressure information calculated by the central ABS computer.

2. A tire pressure monitoring system as in claim 1 further including a hole in the wheel rim near the brake assembly area.

3. A tire pressure monitoring system as in claim 2 wherein the tire pressure sensor transmitter antenna passes into or protrudes through the wheel rim hole.

4. A tire pressure monitoring system as in claim 2 wherein the tire pressure sensor transmitter antenna passes through the wheel rim hole and wraps around part or all of the circumference of the wheel rim near the brake assembly area.

5. A tire pressure monitoring system as in claim 1 further including a tire pressure sensor transmitter antenna embedded in the rim around part or all of the circumference of a non-metallic wheel rim near the brake assembly area.

6. A tire pressure monitoring system as in claim 1 in which the existing ABS wheel sensor signal wire or shield either functions as or is modified to function as the receiver antenna.

7. A tire pressure monitoring system as in claim 1 in which an insulated metal surface that is part of the ABS wheel sensor assembly functions as the receiver antenna.

8. A tire pressure monitoring system as in claim 1 in which the receiver antenna consists of a length of wire wrapped around part or all of the circumference of the ABS brake assembly in close proximity to the wheel rim.

9. A low cost method of providing a vehicle direct tire pressure monitoring system comprising the steps of:
a. mounting a wireless direct tire pressure sensor unit on the wheel rim inside each tire to be monitored;
b. adding receiver antenna and electronics to each wheel's existing ABS wheel sensor unit to receive and condition the transmitted signal from the tire pressure sensor;
c. using the existing ABS wheel sensor vehicle wiring to couple the tire pressure sensor signal received by the ABS wheel sensors to the ABS central computer;
d. modifying the software in the existing central ABS computer to process the tire pressure sensor signals and calculate tire pressure information; and
e. displaying the calculated tire pressure information to the vehicle driver.

10. A low cost method of providing a vehicle direct tire pressure monitoring system as in claim 9 comprising the further step of adding a hole in the wheel rim near the brake assembly area.

11. A low cost method of providing a vehicle direct tire pressure monitoring system as in claim 10 comprising the further step of passing the tire pressure sensor transmitter antenna into or through the wheel rim hole.

12. A low cost method of providing a vehicle direct tire pressure monitoring system as in claim 10 comprising the further step of passing the tire pressure sensor transmitter antenna through the wheel rim hole and wrapping it around part or all of the circumference of the wheel rim near the brake assembly area.

13. A low cost method of providing a vehicle direct tire pressure monitoring system as in claim 9 comprising the further step of embedding the tire pressure sensor transmitter antenna in a non-metallic wheel rim around part or all of its circumference near the brake assembly area.

14. A low cost method of providing a vehicle direct tire pressure monitoring system as in claim 9 comprising the further step of using the existing ABS wheel sensor signal wire or shield to function as, or modifying it to function as, the receiver antenna.

15. A low cost method of providing a vehicle direct tire pressure monitoring system as in claim 9 comprising the further step in which the receiver antenna if formed by wrapping a length of wire around part or all of the circumference of the ABS brake assembly in close proximity to the wheel rim.
